(19) United States
(12) Patent Application Publication
(10) Pub. No.: US 2020/0198254 A1
(43) Pub. Date: Jun. 25, 2020

(54) In Situ Optical Feedback

(71) Applicant: Branson Ultrasonics Corporation, Danbury, CT (US)

(72) Inventors: Scott CALDWELL, New Milford, CT (US); Sean TRIMBY, Geneseo, NY (US); Raul PASOLS, Rochester, NY (US)

(73) Assignee: Branson Ultrasonics Corporation, Danbury, CT (US)

(21) Appl. No.: 16/613,262

(22) PCT Filed: May 23, 2018
(86) PCT No.: PCT/US18/34187

§ 371 Date: Nov. 13, 2019

Related U.S. Application Data
(60) Provisional application No. 62/511,403, filed on May 26, 2017.

(51) Int. Cl. B29C 65/16; B29C 65/00; B23K 26/70

(52) U.S. Cl. CPC B29C 65/1687; B29C 65/1635; B23K 26/324; B23K 26/707; B29C 66/95

(57) ABSTRACT

Sensors incorporated within a waveguide detect a laser light output from at least a laser delivery optical fiber to provide in situ feedback of the laser light intensity detected by the sensor. The sensors may detect laser light directly from the laser delivery optical fiber or as reflected back from a plurality of work pieces during a weld cycle. In various aspects, the feedback provided from the sensors is used to control the laser light intensity or to alert an operator that the laser light intensity is below a predetermined parameter.

### CROSS-REFERENCE TO RELATED APPLICATIONS

This application claims the benefit of U.S. Provisional Application No. 62/511,403 filed on May 26, 2017. The entire disclosure of the above application is incorporated herein by reference.

### FIELD

The present disclosure relates to plastics welding and, more particularly, relates to assessing optical fibers in direct delivery welding and simultaneous laser welding applications.

### BACKGROUND

This section provides background information related to the present disclosure which is not necessarily prior art.

Laser welding is commonly used to join plastic or resinous parts, such as thermoplastic parts, at a welding zone.

There are many different laser welding technologies. One useful technology is simultaneous through transmissive infrared welding, referred to herein as STTIr. In STTIr, the full weld path or area (referred to herein as the weld path) is simultaneously exposed to laser radiation, such as through a coordinated alignment of a plurality of laser light sources, such as laser diodes. An example of STTIr is described in U.S. Pat. No. 6,528,755 for “Laser Light Guide for Laser Welding,” the entire disclosure of which is incorporated herein by reference. In STTIr, the laser radiation is typically transmitted from one or more laser sources to the parts being welded through one or more optical waveguides which conform to the contours of the parts' surfaces being joined along the weld path. To ensure an accurate and comprehensive weld, the gap between any waveguide and the workpiece closest to the waveguide is kept as small as possible. Correspondingly, to improve efficiency, the gap between the delivery end of the fiber bundle and the waveguide is also kept as small as possible.

### SUMMARY

This section provides a general summary of the disclosure, and is not a comprehensive disclosure of its full scope or all of its features.

The present technology provides a method for sensing the output of laser light intensity used to weld a plurality of work pieces in a simultaneous laser welding system. The method includes directing a laser source from a laser bank through a plurality of laser delivery bundles, wherein each of the plurality of laser delivery bundles are comprised of at least a laser delivery optical fiber. The plurality of laser delivery bundles deliver laser light through the at least the laser delivery optical fiber through a waveguide to the plurality of work pieces to be welded. A plurality of sensors is incorporated within the waveguide, and each sensor senses a laser light output by one of the plurality of the laser delivery bundles. In other embodiments, incorporating the plurality of sensors within the waveguide comprises incorporating at least a sensor positioned within the waveguide to sense laser light directed from a delivery end of at least an associated laser delivery optical fiber. In yet other embodiments, the incorporating a plurality of sensors within the waveguide comprises incorporating at least a sensor positioned within the waveguide to sense laser light in a direction substantially parallel to the direction in which laser light is delivered at the delivery end of the laser delivery optical fiber. In further embodiments, the plurality of sensors relays the sensed laser light output to a controller. In other such further embodiments, a user is alerted via the controller when a sensor senses that a laser light output by one of the plurality of the laser delivery bundles is below a predetermined parameter. In yet other such further embodiments, the laser light intensity of the laser delivery bundle is adjusted via the controller when a sensor senses that a laser light output by one of the laser delivery bundles is unsatisfactory. In even further embodiments, directing the laser source from a laser bank through a plurality of laser delivery bundles further comprises delivering laser light through a plurality of legs.

The present technology also provides a laser welding apparatus. The laser welding apparatus comprises a laser bank for outputting from a laser source laser light through a plurality of laser delivery bundles through a wave guide to a plurality of work pieces to be welded. Each laser delivery bundle comprises at least a laser delivery optical fiber. At least a sensor is incorporated within the wave guide for sensing the laser light output by one of said plurality of laser delivery bundles, and the at least a sensor relays the sensed laser light output to a controller. In other embodiments, the at least a sensor is positioned within the waveguide to face the delivery end of at least an associated laser delivery optical fiber. In yet other embodiments, the at least a sensor is positioned within the waveguide in a direction substantially parallel to the direction in which laser light is delivered at the delivery end of the laser delivery optical fiber. In further embodiments, the controller is configured to alert a user that a laser light output by one of said laser delivery bundles is below a predetermined parameter. In even further embodiments, the controller is configured to adjust the laser light output by one of said laser delivery bundles when the laser light output by one of the laser delivery bundles is unsatisfactory. In yet further embodiments, the at least a laser delivery bundle is comprised of a plurality of legs.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view illustrating a prior art laser welder;

FIG. 2 is a schematic view illustrating an embodiment according to the present disclosure;

FIG. 3 is a schematic view illustrating an embodiment according to another aspect of the present disclosure;

FIG. 4 is an enlarged schematic view illustrating the positioning of sensors in a waveguide according to the present disclosure;

FIG. 5 is an enlarged schematic view illustrating an alternative positioning of sensors in a waveguide according to the present disclosure;

FIG. 6 is an enlarged schematic view illustrating yet other alternative positioning of sensors in a waveguide according to the present disclosure;

FIG. 7 is a flow chart of control logic for a control routine for determining whether a laser delivery bundle is delivering satisfactory laser light intensity; and

FIG. 8 is another flow chart of control logic for a control routine for determining whether a laser delivery bundle is delivering satisfactory laser light intensity.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

It should be understood for any recitation of a method, composition, device, or system that “comprises” certain steps, ingredients, or features, that in certain alternative variations, it is also contemplated that such a method, composition, device, or system may also “consist essentially of” the enumerated steps, ingredients, or features, so that any other steps, ingredients, or features that would materially alter the basic and novel characteristics of the invention are excluded therefrom.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. If, for some reason, the imprecision provided by “about” is not otherwise understood in the art with this ordinary meaning, then “about” as used herein may indicate a possible variation of up to 5% of the indicated value or 5% variance from usual methods of measurement.

As used herein, the term “composition” refers broadly to a substance containing at least the preferred metal elements or compounds, but which optionally comprises additional substances or compounds, including additives and impurities. The term “material” also broadly refers to matter containing the preferred compounds or composition.

In addition, disclosure of ranges includes disclosure of all values and further divided ranges within the entire range, including endpoints and sub-ranges given for the ranges.

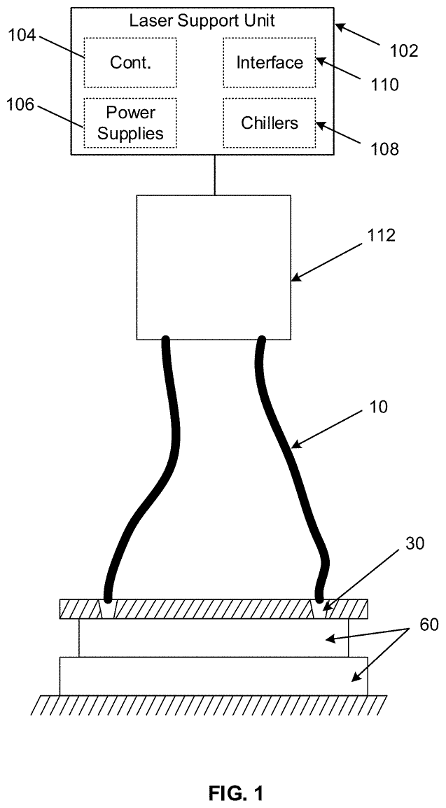

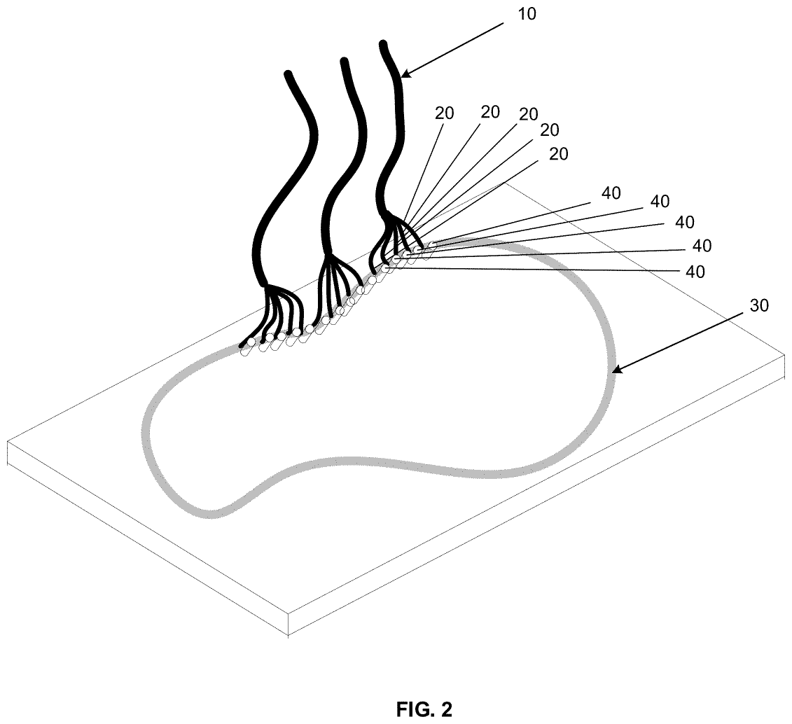

The technology according to the present disclosure provides methods and apparatuses for use in simultaneous laser welding. Under conventional methods for simultaneous laser welding and with reference to the prior art laser welder shown in FIG. 1, a laser bank 112 directs a laser source through a plurality of laser delivery bundles 10. Each laser delivery bundle 10 may be further split into legs 20 (as shown in FIG. 2) and each leg 20 is comprised of at least a laser delivery optical fiber. Notably, if laser delivery bundle 10 is not split into legs 20, then each laser delivery bundle 10 is comprised of at least a laser delivery optical fiber. Each laser delivery optical fiber delivers laser light from laser bank 112 through a waveguide 30 to a plurality of work pieces 60 to be welded together. Waveguide 30 homogenizes the laser light delivered to work pieces 60 through each laser delivery optical fiber.

Under many aspects, the embodiments described according to the present disclosure may be used as part of an STTIr laser welding system. Referring again to FIG. 1, an exemplary prior art STTIr system includes a laser support unit 102 including one or more controllers 104, an interface 110, one or more power supplies 106, and one or more chillers 108. Laser support unit 102 is in electrical communication with sensors 40. The STTIr laser welding system may also include an actuator, one or more laser banks 112, and an upper tool/waveguide assembly and a lower tool fixtured on a support table. Laser support unit 102 is coupled to the actuator and each laser bank 112 and provides power and cooling via power supply (or supplies) 106 and chiller (or chillers) 108 to laser banks 112 and controls the actuator and laser banks 112 via controller 104. The actuator is coupled to the upper tool/waveguide assembly and moves it to and from the lower tool under control of controller 104.

Referring to FIG. 2, and further expounding upon the simultaneous laser welder described according to FIG. 1, according to an embodiment of the present disclosure, at least a sensor 40 is incorporated in waveguide 30. Sensor 40 is positioned within waveguide 30 so that an input end of sensor 40 senses the output laser light at the delivery end (i.e., the end of the laser delivery optical fiber where laser light is directed to plurality of work pieces 60 to be welded) of an associated laser delivery optical fiber. Sensor 40 is in electrical communication with and relays the sensed output laser light to controller 104 to provide in situ feedback of the laser light intensity sensed by sensor 40. Notably, while FIG. 2 shows a matching number of sensors 40 to legs 20, it is also contemplated there may be fewer or more sensors 40 in relation to the number of legs 20. Having multiple sensors 40, where each sensor 40 is associated with a corresponding leg 20, offers benefits in that each leg 20 may be sensed by its corresponding sensor 40, thereby immediately signaling whether a particular leg 20 is emitting an unsatisfactory laser light intensity. By way of non-limiting example, where each leg 20 comprises a plurality of laser delivery optical fibers, waveguide 30 may be equipped with a corresponding number of sensors 40 positioned to sense laser light output of each laser delivery optical fiber. What is desirable, however, is that there are sufficient sensors 40 to detect the laser output at the delivery end of each leg. 10.

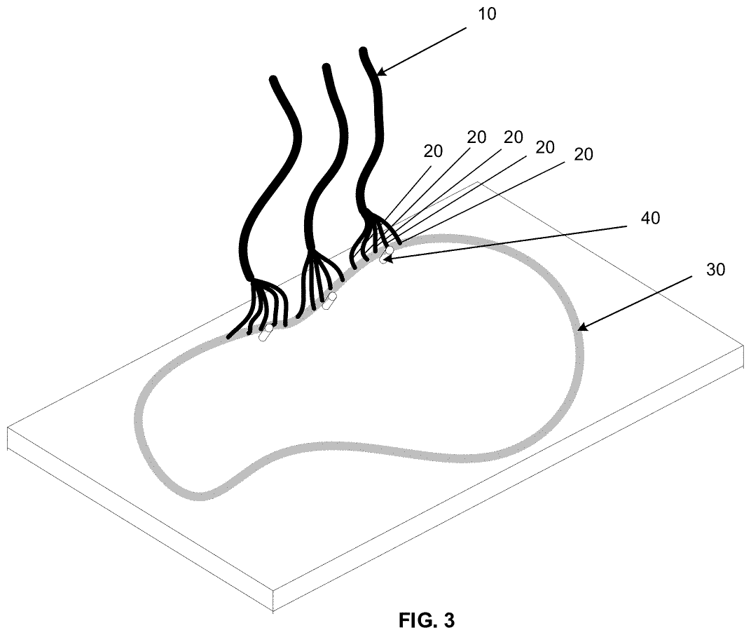

Referring to FIG. 3, an alternate embodiment is disclosed. Like in FIG. 1, this alternate embodiment includes a conventional method for simultaneous welding, wherein at least a laser delivery bundle 10 receives laser light from a laser bank 112. Each laser delivery bundle 10 may be further split into legs 20 and each leg 20 is comprised of at least a laser delivery optical fiber. Notably, if laser delivery bundle 10 is not split into legs 20, then each laser delivery bundle 10 is comprised of at least a laser delivery optical fiber. Each laser delivery optical fiber delivers laser light from laser bank 112 through waveguide 30 to plurality of work pieces 60 to be welded together. Under the embodiment shown in FIG. 3, a single sensor 40 is provided for each laser delivery bundle 10, regardless of the number of legs 20 or laser delivery optical fibers that comprise laser delivery bundle 10, and senses the output laser light at the delivery end of each laser delivery optical fiber associated with that laser delivery bundle 10. Sensor 40 is in electrical communication with and relays the sensed output laser light to controller 104 to provide in situ feedback of the laser light intensity sensed by sensor 40.

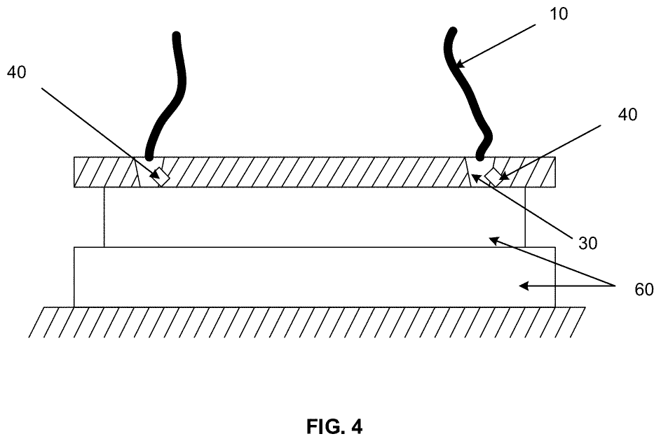

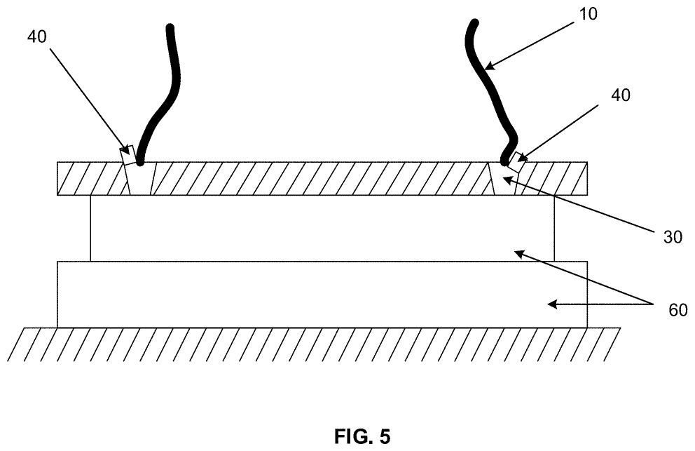

In any of the preceding embodiments, it is contemplated that sensor 40 may be positioned in a way in which sensor 40 directly intercepts at least a portion of the output of laser light delivered via a laser delivery optical fiber, as shown in FIG. 4 (e.g., by positioning sensor 40 to sense laser light directed from the delivery end of an associated laser delivery optical fiber). In yet other embodiments, it is contemplated that sensor 40 may be positioned in a way in which sensor 40 senses laser light reflected back from work pieces 60 during a weld cycle, as shown in FIG. 5 (e.g., by positioning sensor 40 to look in a direction substantially parallel to the direction in which laser light is delivered at the end of an associated laser delivery optical fiber).

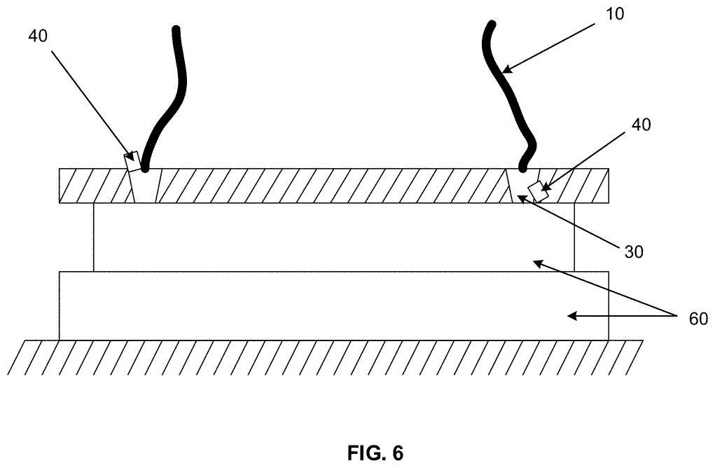

Further, where multiple laser delivery bundles 10 are contemplated (e.g., in STTIr applications), at least a sensor 40 may be integrated into waveguide 30 to intercept at least a portion of the output of laser light delivered via a laser delivery optical fiber, whereas at least another sensor 40 may be integrated into waveguide 30 to sense laser light reflected back from work pieces 60 during a weld cycle, as shown in FIG. 6.

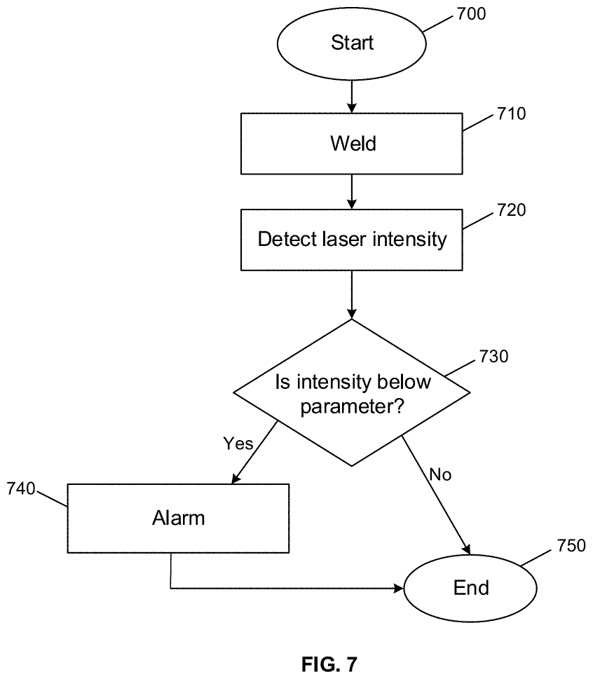

FIG. 7 is a flow chart of control logic for an example control routine implemented in controller 104 for determining whether a laser delivery bundle (such as laser delivery bundle 10) is delivering satisfactory laser light intensity. The control routine starts at 700 and proceeds to 710 to begin a weld cycle. The control routine proceeds to 720, where, during the weld cycle, a sensor (e.g., sensor 40) senses the laser light intensity. The control routine proceeds to 730, where controller 104 determines whether the laser intensity detected by the sensor is below a predetermined parameter. If controller 104 determines the detected laser intensity is below a predetermined parameter, the control routine proceeds to 740, and controller 104 issues an alarm to alert a user indicating same. After issuing the alarm or determining no alarm is required, the control routine proceeds to end 750.

In further embodiments, the fiber feedback system further includes a closed control loop, as described in U.S. Pat. No. 7,343,218, which is commonly owned by the same assignee and is incorporated herein by reference.

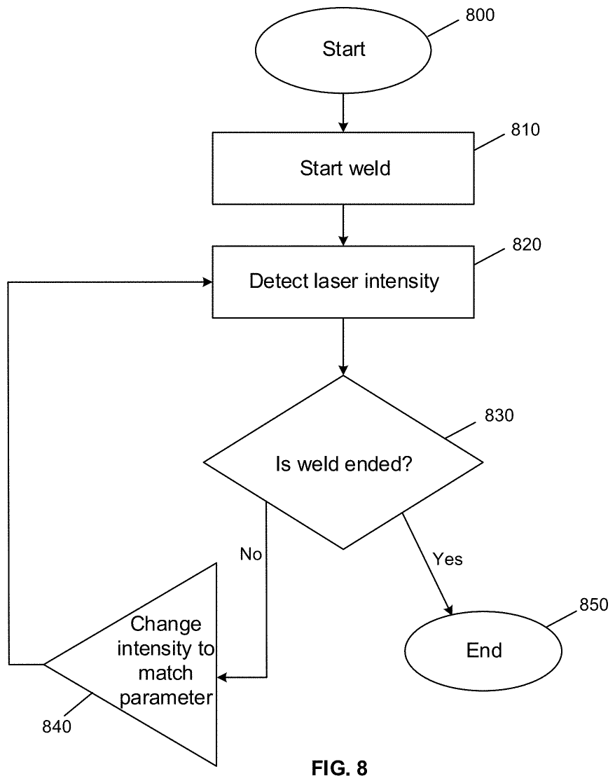

FIG. 8 is a flow chart of control logic for an example control routine implemented in controller 104 for determining whether a laser delivery bundle (such as laser delivery bundle 10) is delivering satisfactory laser light intensity. The control routine starts at 800 and proceeds to 810 to begin a weld cycle. The control routine proceeds to 820, where, during the weld cycle, a sensor (e.g., sensor 40) senses the laser light intensity. The control routine proceeds to 830, where controller 104 determines whether the weld routine is done. If controller 104 determines that the weld routine is not done, the control routine proceeds to 840, and controller 104 adjusts the intensity of the laser delivery bundle to bring the intensity within a predetermined range. After adjusting the intensity or determining no such adjustment is warranted, the control routine proceeds back to detecting laser intensity 820. If it is determined that the weld routine is done in 830, control routine proceeds to end 850.

Controller 104 can be or includes any of a digital processor (DSP), microprocessor, microcontroller, or other programmable device which are programmed with software implementing the above described logic. It should be understood that alternatively it is or includes other logic devices, such as a Field Programmable Gate Array (FPGA), a complex programmable logic device (CPLD), or application specific integrated circuit (ASIC). When it is stated that controller 104 performs a function or is configured to perform a function, it should be understood that controller 104 is configured to do so with appropriate logic (such as in software, logic devices, or a combination thereof), such as control logic shown in the flow charts of FIGS. 7 and 8. When it is stated that controller 104 has logic for a function, it should be understood that such logic can include hardware, software, or a combination thereof.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for sensing the output of laser light intensity used to weld a plurality of work pieces in a simultaneous laser welding system, the method comprising:
directing a laser source from a laser bank through a plurality of laser delivery bundles, wherein each of the plurality of laser delivery bundles are comprised of at least a laser delivery optical fiber, wherein the plurality of laser delivery bundles deliver laser light through the at least the laser delivery optical fiber through a waveguide to the plurality of work pieces to be welded; and
incorporating a plurality of sensors within the waveguide, wherein each sensor senses a laser light output by one of the plurality of the laser delivery bundles.

2. The method according to claim 1, wherein the incorporating a plurality of sensors within the waveguide comprises incorporating at least a sensor positioned within the waveguide to sense laser light directed from a delivery end of at least an associated laser delivery optical fiber.

3. The method according to claim 1, wherein the incorporating a plurality of sensors within the waveguide comprises incorporating at least a sensor positioned within the waveguide to sense laser light in a direction substantially parallel to the direction in which laser light is delivered at the delivery end of the laser delivery optical fiber.

4. The method according to claim 1, wherein the plurality of sensors relays the sensed laser light output to a controller.

5. The method according to claim 4, further comprising alerting a user via the controller when a sensor senses that a laser light output by one of the plurality of the laser delivery bundles is below a predetermined parameter.

6. The method according to claim 4, further comprising adjusting the laser light intensity of a laser delivery bundle via the controller when a sensor senses that a laser light output by one of said laser delivery bundle is unsatisfactory.

7. The method according to claim 1, wherein the directing a laser source from a laser bank through a plurality of laser delivery bundles further comprises delivering laser light through a plurality of legs.

8. A laser welding apparatus, the laser welding apparatus comprising:
a laser bank for outputting from a laser source laser light through a plurality of laser delivery bundles through a wave guide to a plurality of work pieces to be welded, wherein each said laser delivery bundle is comprised of at least a laser delivery optical fiber; and
at least a sensor incorporated within said wave guide for sensing said laser light output by one of said plurality of laser delivery bundles, wherein said at least a sensor relays the sensed laser light output to a controller.

9. The laser welding apparatus of claim 8, wherein the at least a sensor is positioned within the waveguide to face a delivery end of at least an associated laser delivery optical fiber.

10. The laser welding apparatus of claim 8, wherein the at least a sensor is positioned within the waveguide in a direction substantially parallel to the direction in which laser light is delivered at a delivery end of the laser delivery optical fiber.

11. The laser welding apparatus of claim 8, wherein the controller is configured to alert a user that a laser light output by one of said laser delivery bundles is below a predetermined parameter.

12. The laser welding apparatus of claim 8, wherein the controller is configured to adjust the laser light output by one of said laser delivery bundles when the laser light output by one of said laser delivery bundles is unsatisfactory.

13. The laser welding apparatus of claim 8, wherein at least a laser delivery bundle is comprised of a plurality of legs.
